(19) United States
(12) Patent Application Publication
(10) Pub. No.: US 2017/0114703 A1
(43) Pub. Date: Apr. 27, 2017

(54) CARTRIDGE HEATER FOR THERMOSTAT AND MANUFACTURING METHOD OF THE SAME

(71) Applicant: INZICONTROLS CO., LTD., Gyeonggi-do (KR)

(72) Inventors: Yong-Jeong KIM, Ansan-si, Gyeonggi-do (KR); Hee-Hwa JOUNG, Ansan-si, Gyeonggi-do (KR)

(21) Appl. No.: 15/316,994

(22) PCT Filed: May 27, 2015
(86) PCT No.: PCT/KR2015/005310

§ 371 Date: Dec. 7, 2016

(30) Foreign Application Priority Data
Jun. 18, 2014 (KR) 10-2014-0074421

(51) Int. Cl. F01P 7/16; B23P 15/00

(52) U.S. Cl. CPC F01P 7/167; B23P 15/001; F01P 2070/04

(57) ABSTRACT

Disclosed are a cartridge heater for a thermostat and a manufacturing method of the same. The cartridge heater for a thermostat inserted into wax that reciprocatively moves a piston while being expanded and contracted according to a temperature in a wax cylinder embedded in the thermostat and used for selectively transferring heat to the wax by depending on whether power is applied, includes: a bobbin around which a coil connected with each of lead wires connected with external power and inserted therein is wound on the outer periphery thereof; a heating tube of which one end is closed and the other end is initially opened, the bobbin being inserted toward the closed end from the initially opened end therein, such that the lead wires protrude to the outside and the closed end is inserted into the wax; a filling material filled in the heating tube into which the bobbin is inserted; an insulating cap mounted on the initially opened end of the heating tube in which the filling material is filled while being penetrated by the lead wires; and a joining body mounted on the other end of the heating tube and joined to the wax cylinder while covering the outer periphery of the closed end of the heating tube.

### CROSS-REFERENCE TO RELATED APPLICATION(S)

This application is the U.S. National Phase application of PCT application number PCT/KR2015/005310 having a PCT filing date of May 27, 2015, which claims priority of Korean patent application 10-2014-0074421 filed on Jun. 18, 2014, the disclosures of which are hereby incorporated by reference.

### TECHNICAL FIELD

The present invention relates to a cartridge heater for a thermostat and a manufacturing method of the same, and more particularly, to a cartridge heater for a thermostat which is mounted in an electronic thermostat and heated according to application of power to actuate the thermostat, and a manufacturing method of the same.

### BACKGROUND ART

In general, a vehicular thermostat is installed between an engine and a radiator, and is automatically opened/closed according to a change in temperature of cooling water to control a flow of the cooling water into the radiator to serve to maintain the cooling water at an appropriate temperature.

The thermostat controls the flow of the cooling water depending on an opening/closing displacement of a valve to control the temperature of the engine.

The current vehicular thermostat mainly includes mechanical thermostats having a structure in which expansion force of wax which is expanded according to the temperature of the cooling water is transferred to a piston to cause the opening/closing displacement of the valve.

That is, the mechanical thermostat in the related art is constituted by a frame installed in a cooling water path, a valve opening/closing the cooling water path, a spring supporting the valve, a capsule including the wax and the piston, and the like, and is configured in an actuation scheme in which, when the temperature of the cooling water increases up to a defined temperature (approximately 80 to 90 □C.), the wax is changed from a solid state to a liquid state and force generated by a volume change thereof is transferred to the piston to actuate the valve.

Since the mechanical thermostat configured as such is a type in which the mechanical thermostat operates according to an opening/closing temperature set to the defined temperature of the cooling water, that is, a type in which the valve is opened/closed only at a predetermined temperature, there is a limit in actively coping with a change in driving environment or other conditions of a vehicle by considering a recent trend in which vehicles are obtaining higher performance and higher efficiency.

As a result, in recent years, there has been a trend in which a variable control type of electronic thermostat for maintaining the cooling water temperature of the engine at an optimal state while ameliorating a disadvantage of the mechanical thermostat is presented.

The electronic thermostat controls the cooling water temperature of the engine according to the driving environment including a load state of the vehicle and the like to constantly maintain an optimal engine cooling state, and to produce a fuel efficiency enhancement effect and an exhaust gas reduction effect as compared with the mechanical thermostat.

A general electronic thermostat usually has a structure that additionally includes a cartridge heater having a plug for supplying power to a basic component of the mechanical thermostat in the related art and the wax to variably control an opening/closing time of the valve by controlling heat of the cartridge heater according to the driving environment of the vehicle, which includes a velocity of the vehicle, a temperature of intake air, a load of the engine, and the like, by using a separate heat source generating heat when supplying the power.

The electronic thermostat in the related art interrupts a negative (−) polarity and continuously supplies a positive (+) polarity when stopping the application of the power. However, since the negative (−) polarity flows to a ground power supply of a vehicle body, a potential is generated in the cartridge heater, and as a result, contaminants may be generated due to a change in ion leakage in a packing material from the inside of the thermostat such that the electricity flow is continued. Therefore, there is a problem in that the thermostat malfunctions or operating responsiveness deteriorates.

Further, a bobbin wound with a coil connected to a lead wire is directly inserted into the wax at the time of mounting the cartridge heater, and as a result, the coil connected with the lead wire may be short-circuited while the cartridge heater is mounted. Therefore, the electronic thermostat in the related art also has a problem in that a defect occurs and a required time for the mounting increases.

### DISCLOSURE

### Technical Problem

The present invention has been made in an effort to provide a cartridge heater for a thermostat and a manufacturing method of the same which prevent a filling material filled in a heating tube and foreign materials which can be generated as a result of an ionic change of the filling material by continuously applying power due to a ground current of a vehicle body even at the time of stopping supply of the power from leaking to the outside of the heating tube in an electronic thermostat to prevent malfunction of the thermostat and improve mountability.

### Technical Solution

An exemplary embodiment of the present invention provides a cartridge heater for a thermostat inserted into wax that reciprocatively moves a piston while being expanded and contracted according to a temperature in a wax cylinder embedded in the thermostat and used for selectively transferring heat to the wax depending on whether power is applied, including: a bobbin around which a coil connected with each of lead wires connected with external power and inserted therein is wound on the outer periphery thereof; a heating tube of which one end is closed and the other end is initially opened, the bobbin being inserted toward the closed end from the initially opened end therein, such that the lead wires protrude to the outside and the closed end is inserted into the wax; a filling material filled in the heating tube into which the bobbin is inserted; an insulating cap mounted on the initially opened end of the heating tube in which the filling material is filled while being penetrated by the lead wires; and a joining body mounted on the other end of the heating tube and joined to the wax cylinder while covering the outer periphery of the closed end of the heating tube.

The insulating cap may seal the inside of the heating tube.

The heating tube may strengthen a connection of the lead wires and the coil together with the filling material while formation of an outer-diameter size is completed as a set size through swaging molding in a state where the insulating cap is mounted.

The heating tube may be made of a cylindrical metallic material, and the closed end may be formed with a curved surface.

The heating tube may be press-fitted into the joining body.

In the joining body, a thread may be formed along the circumference of the outer periphery, and the joining body may be screw-joined to the wax cylinder through the thread.

A bush may be mounted on the joining body, and fixes the lead wires that protrude to the outside from the end which is opposite to that of the heating tube.

The outer periphery of the end of the joining body on which the bush is mounted may be formed to be inclined through curling (pursing) molding.

The filling material may be composed of magnesium oxide (MgO) powder which forms an insulating member.

One end of the coil may be connected with one lead wire and the other end may be connected to another lead wire among the respective lead wires.

Another exemplary embodiment of the present invention provides a manufacturing method of a cartridge heater for a thermostat, including: (A) a process of inserting lead wires into a bobbin and connecting the lead wires to a coil wound around the bobbin; (B) a process of mounting the bobbin manufactured through the process (A) in a heating tube and completing formation of an outer-diameter size of the heating tube while filling a filling material in the heating tube; and (C) a process of mounting the heating tube of which the formation of the outer-diameter size is completed through the process (B) in a joining body and fixing the lead wires.

The process (A) may include inserting the lead wires into the bobbin, winding the coil on the outer periphery of the bobbin, and connecting respective ends the coil wound on the outer periphery of the bobbin with the respective lead wires.

In the connecting of the coil and the lead wires, among the respective lead wires, one end of the coil may be connected to one lead wire and the other end of the coil may be connected with the other lead wire.

The process (B) may include inserting the bobbin into the heating tube, filling the filling material into the heating tube into which the bobbin is inserted, mounting an insulating cap on the heating tube filled with the filling material, and completing formation of an outer-diameter size of the heating tube through swaging molding.

The filling material may be composed of magnesium oxide (MgO) powder which forms an electrical insulating member.

The insulating cap may seal the inside of the heating tube to prevent the filling material from leaking to the outside of the heating tube.

In the completing of the formation of the outer-diameter size of the heating tube, connection of the coil and the respective lead wires together with the filling material may be strengthened while completing the formation of the outer-diameter size of the heating tube as a set size.

In the completing of the formation of the outer-diameter size of the heating tube, a closed end of the heating tube made of a cylindrical metallic material may be molded to have a curved surface.

The process (C) may include press-fitting and mounting the closed end of the heating tube of which the formation of the outer-diameter size is completed through the process (B) in and on the joining body so that a predetermined part of the closed end protrudes, mounting a bush on the end of the joining body from which the respective lead wires which protrude from the heating tube protrude to the outside, and curling (pursing) molding the circumference of the outer periphery of the end of the joining body on which the bush is mounted.

The bush may fix the respective penetrated lead wires while sealing the inside of the joining body.

### Advantageous Effects

As described above, according to exemplary embodiments of the present invention, a cartridge heater for a thermostat and a manufacturing method of the same prevent a filling material filled in a heating tube and foreign materials which can be generated due to an ionic change of the filling material caused by continuously applying power due to a ground current of a vehicle body even at the time of stopping supply of the power from leaking to the outside of the heating tube in an electronic thermostat to prevent a malfunction of the thermostat.

Further, the heating tube is smoothly inserted into wax while preventing the heating tube from being separated by press-fitting the heating tube into a joining body, and the heating tube is more conveniently mounted on the thermostat by applying a screw joining structure to improve mountability and reduce a required time for mounting.

In addition, the malfunction of the thermostat is prevented and operating reliability of the cartridge heater is improved to increase reliability and responsiveness of the thermostat, thereby improving overall marketability.

### BRIEF DESCRIPTION OF THE DRAWINGS

FIG. 1 is a cross-sectional view illustrating a state in which a cartridge heater for a thermostat is mounted on a wax assembly according to an exemplary embodiment of the present invention.

FIG. 2 is a perspective view of a cartridge heater for a thermostat according to an exemplary embodiment of the present invention.

FIG. 3 is a cross-sectional view taken along line A-A of FIG. 2.

FIG. 4 is a process block diagram illustrating a manufacturing method of a cartridge heater for a thermostat for each step according to an exemplary embodiment of the present invention.

FIG. 5 is a manufacturing state diagram for each step of the manufacturing method of a cartridge heater for a thermostat according to the exemplary embodiment of the present invention.

### MODE FOR INVENTION

Hereinafter, exemplary embodiments of the present invention will now be described in detail with reference to the accompanying drawings.

Configurations illustrated in the exemplary embodiments and drawings disclosed in the present specification are only the most preferred embodiments of the present invention and do not represent all of the technical spirit of the present invention, and thus it is to be understood that various equivalents and modified examples which may replace the configurations are possible, when filing the present application.

Parts not associated with description are omitted for clearly describing the exemplary embodiments of the present invention, and like reference numerals designate like elements throughout the specification.

Since sizes and thicknesses of each component illustrated in the drawings are arbitrarily represented for convenience in explanation, the present invention is not particularly limited to the illustrated sizes and thicknesses of each component, and the sizes and thicknesses are enlarged in order to clearly express various parts and areas.

Throughout the specification, unless explicitly described to the contrary, the word “comprise” and variations such as “comprises” or “comprising” will be understood to imply the inclusion of stated elements but not the exclusion of any other elements.

In addition, the terms “unit”, “means”, “part”, “member”, or the like, which are described in the specification, mean units of a comprehensive configuration that perform at least one function or operation.

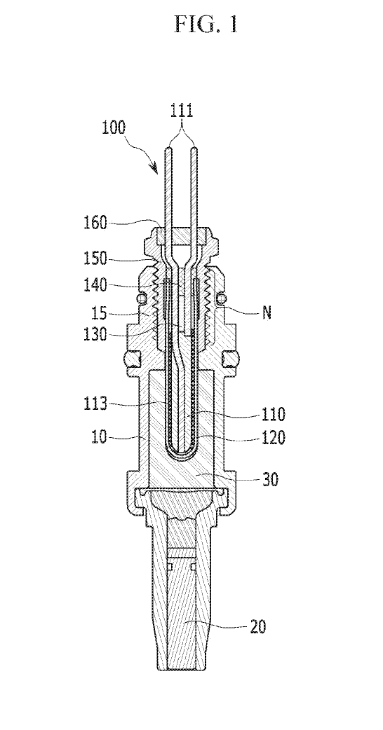

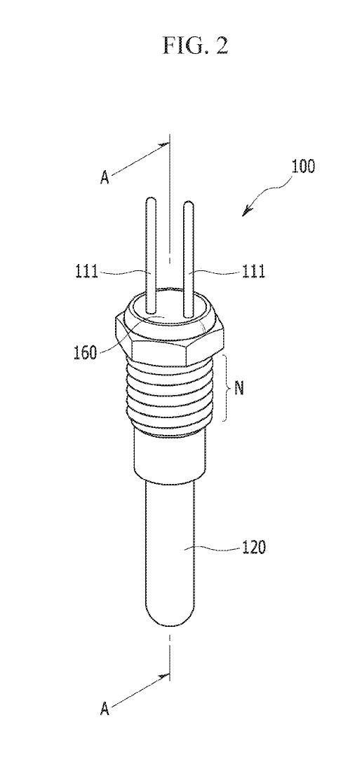

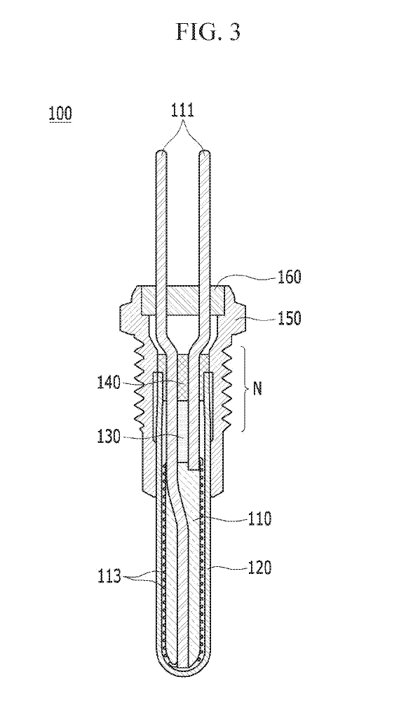

FIG. 1 is a cross-sectional view illustrating a state in which a cartridge heater for a thermostat is mounted on a wax assembly according to an exemplary embodiment of the present invention, FIG. 2 is a perspective view of a cartridge heater for a thermostat according to an exemplary embodiment of the present invention, and FIG. 3 is a cross-sectional view taken along line A-A of FIG. 2.

Referring to the drawings, according to exemplary embodiments of the present invention, a cartridge heater 100 for a thermostat prevents a filling material 130 filled in a heating tube 120 and foreign materials which can be generated due to an ionic change of the filling material 130 caused by continuously applying power due to a ground current of a vehicle body even at the time of stopping supply of the power from leaking to the outside of the heating tube in an electronic thermostat to prevent a malfunction of the thermostat and improve mountability.

To this end, the cartridge heater 100 for a thermostat according to the exemplary embodiment of the present invention is inserted into wax 30 which reciprocatively moves a piston 20 while being expanded and contracted according to a temperature in a wax cylinder 10 embedded in the thermostat, as illustrated in FIG. 1.

Herein, the wax cylinder 10 has a wax accommodation space in which the wax 30 is filled, and has a fixation unit 15 on which the cartridge heater 100 is mounted formed on the top thereof.

That is, the cartridge heater 100 is mounted on the fixation unit 15 of the wax cylinder 10 and is heated according to application of power to selectively transfer heat to the wax 30.

The cartridge heater 100 for the thermostat is configured to include a bobbin 110, a heating tube 120, a filling material 130, an insulating cap 140, and a joining body 150, as illustrated in FIGS. 2 and 3.

First, one end of a lead wire 111 connected to external power is inserted into each of both insides of the bobbin 110, and a coil 113 connected with each lead wire 111 is wound on the outer periphery of the bobbin 110.

Herein, the respective lead wires 111 are connected with the external power through a connector (not illustrated), and as a result, current having different polarities is applied to the respective lead wires 111, and one end of the coil 113 is connected with one lead wire 111 of the respective lead wires 111 and the other end may be connected to another lead wire 111.

That is, as illustrated in FIG. 3, the respective lead wires 111 have different lengths, wherein one lead wire 111 having the longer length is inserted to the bottom of the bobbin 110 through an initially opened end of the bobbin 110 and is connected to one end of the coil 113 wound on the circumference of the outer periphery of the bobbin 110, and the other lead wire 111 having the shorter length is connected to the other end of the coil 113 while a predetermined part thereof is inserted into the bobbin 110 through the initially opened end thereof.

As a result, when the power is supplied to the lead wires 111, the current is transferred to the coil 113 through the lead wires 111 and the coil 113 may be heated while the current flows along the coil 113.

In the exemplary embodiment, one end of the heating tube 120 is closed and the other end is initially opened, and while the bobbin 110 is inserted toward the closed end from the initially opened end, the other ends of the lead wires 111 mounted on the bobbin 110 protrude to the outside.

The closed end of the heating tube 120 is inserted into the wax 30, and the temperature of the wax 30 is increased by using the heat generated by the coil 113 while the chemical corrosion of the coil 113 is blocked.

The filling material 130 is filled in the heating tube 120 while the bobbin 110 is inserted. The filling material 130 may be composed of magnesium oxide (MgO) powder which forms an insulating member.

Herein, the magnesium oxide (MgO) powder as an insulator maintains electrical insulation between the heating tube 120 and the coil 113 so as to prevent the current which flows on the coil 113 from being transferred to the heating tube 120, and prevents the coil from being moved and transfers the heat generated by the coil 113 to the heating tube 120.

Meanwhile, the bobbin 110 is provided in the cartridge heater according to the exemplary embodiment of the present invention, and it is described that the coil 113 is wound on the bobbin 110 while the lead wires 111 are inserted into the bobbin 110 as an exemplary embodiment, but the present invention is not limited thereto, and one end of the coil 113 may be configured to be connected to one lead wire 111 and the other end may be configured to be connected to the other lead wire 111 while the coil 113 is formed in a coil spring shape without the bobbin 110, and is thus connected to the lead wire 111 that is spaced apart from the other lead wire 111 by a predetermined interval.

That is, when the lead wires 111 and the coil 113 are configured, the filling material 130 is filled while the coil 113 connected with the lead wires 111 is inserted into the heating tube 120 even though the bobbin 110 is not provided, and as a result, the filling material 130 filled in the heating tube 120 may substitute for a function of the bobbin 110.

In the exemplary embodiment, the insulating cap 140 is mounted on the initially opened end of the heating tube 120 in which the filling material 130 is filled while being penetrated by the lead wires 111.

The insulating cap 140 seals the inside of the heating tube 120 in which the filling material 130 is filled to prevent the filling material 130 from leaking to the outside of the heating tube 120 and prevent foreign materials, which may be generated by an ionic change of the filling material 130 through continuous power application by the ground current which flows on a vehicle body even when supply of the power to the thermostat stops, from leaking to the outside of the heating tube 120.

Meanwhile, in the exemplary embodiment, the heating tube 120 may strengthen a connection of the lead wires 111 and the coil 113 together with the filling material 130 while formation of an outer diameter size is completed as a set size through swaging molding in a state in which the insulating cap 140 is mounted.

Herein, the heating tube 120 may be made of a cylindrical metallic material, and the closed end of the heating tube 120 may be formed with a curved surface through the swaging molding so as to be smoothly inserted into the wax 30 filled in the wax accommodation space.

That is, the filling material 130 is filled in the heating tube 120 while the bobbin 110 to which the lead wires 111 and the coil 113 are mounted is inserted, and an outer diameter having a set size and the closed end are molded to have the curved surface through the swaging molding while mounting of the insulating cap 140 is completed.

In addition, the joining body 150 is mounted on the other end of the heating tube 120 while covering the outer periphery of the other end of the heating tube 120 and being joined to the wax cylinder 10 to maintain the insertion of the heating tube 120 configured as described above in the wax 30.

Herein, the heating tube 120 is press-fitted and fixed while the closed end protrudes into the joining body 150 by a predetermined distance. As a result, the heating tube 120 may be prevented from being detached from the joining body 150.

In the exemplary embodiment, a thread N may be formed along the circumference of the outer periphery of the joining body 150 which is screw-joined to the fixation unit 15 of the wax cylinder 10 through the thread N.

Further, a bush 160 may be mounted on the joining body 150, and fixes the lead wires 111 that protrude to the outside from the end opposite that of the heating tube 120.

The bush 160 fixes the lead wires 111 while sealing the inside of the joining body 150 to serve to prevent the lead wires 111 from contacting the joining body 150 and causing a short-circuit or from being bent in the joining body 150 by impact energy including vibration generated while the vehicle is driven and strengthen a connection with a power connector (not illustrated).

Meanwhile, in the exemplary embodiment, an outer periphery of an end of the joining body 150 on which the bush 160 is mounted may be formed to be inclined through curling (pursing) molding.

That is, as the circumference of the outer periphery of the end of the joining body 150 is curling (pursing) molded to be inclined at a predetermined angle, an injury which may be caused by a sharp corner of the joining body 150 existing before the curling molding when a worker grips the cartridge heater 100 of which manufacturing is completed or joins the cartridge heater 100 to the wax cylinder 10 is prevented, and a graceful appearance results.

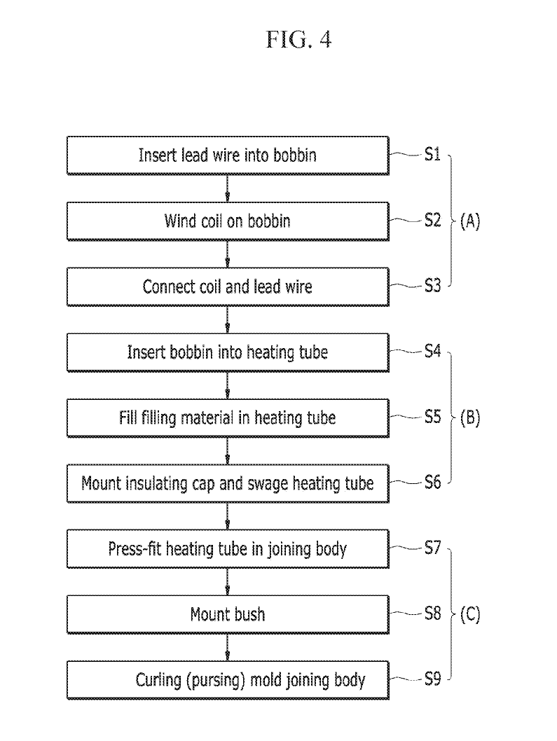

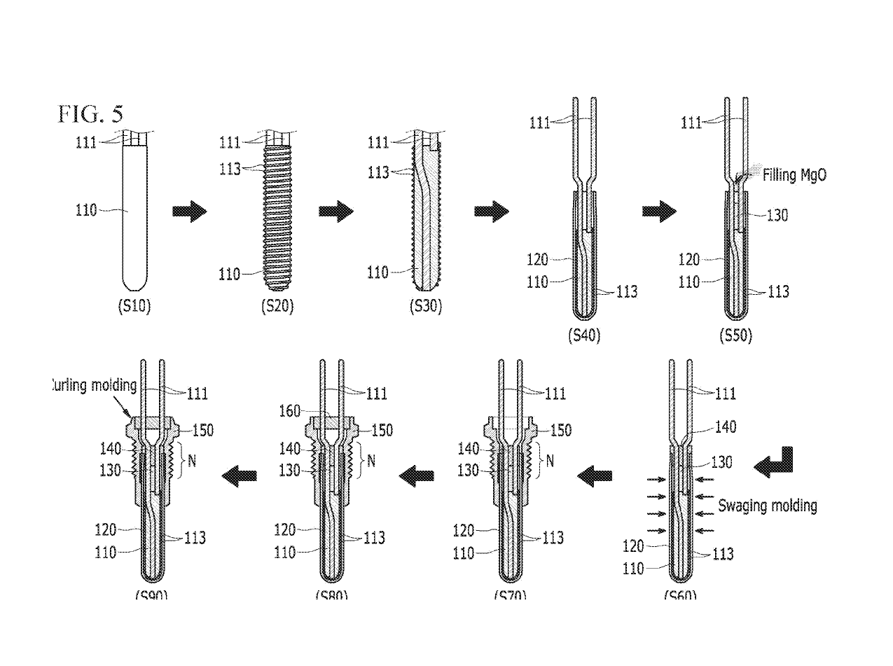

Hereinafter, a manufacturing method of the cartridge heater for the thermostat according to the exemplary embodiment of the present invention, which is configured as such, will be described in detail with reference to FIGS. 4 and 5.

FIG. 4 is a process block diagram illustrating a manufacturing method of a cartridge heater for a thermostat for each step according to an exemplary embodiment of the present invention, and FIG. 5 is a manufacturing state diagram for each step of the manufacturing method of a cartridge heater for a thermostat according to the exemplary embodiment of the present invention.

As illustrated in FIG. 4, the manufacturing method of the cartridge heater for the thermostat according to the exemplary embodiment of the present invention includes (A) a process of inserting the lead wires 111 into the bobbin 110 and connecting the lead wires 111 to the coil 113 wound around the bobbin 110, (B) a process of mounting the bobbin 110 manufactured through the process (A) in the heating tube 120 and completing formation of an outer-diameter size of the heating tube 120 while filling the filling material 130 in the heating tube 120, and (C) a process of mounting the heating tube 120 of which the formation of the outer-diameter size is completed through the process (B) in the joining body 150 and fixing the lead wires 111, and the manufacturing method thereof, will be described below in more detail for each process.

First, in the process (A), as illustrated in S10 of FIG. 5, the lead wires 111 having different lengths are inserted into the bobbin 110 (S1).

Then, the coil 113 is wound along the circumference of the outer periphery of the bobbin 110 in which mounting the lead wires 111 are inserted, as illustrated in S20 of FIG. 5 (S2).

Herein, the coil 113 is wound on the outer periphery of the bobbin 110 while maintaining spacing of gaps at a predetermined interval in the longitudinal direction.

When the step S2 of winding the coil 113 on the bobbin 110 is completed, respective ends of the coil 113 wound on the outer periphery of the bobbin 110 are connected with the respective lead wires 111, as illustrated in S30 of FIG. 5 (S3).

In the step S3 of connecting the coil 113 and the lead wires 111, one end of the coil 113 may be connected to one lead wire 111 which has the longer length and is positioned in the closed end of the bobbin 110, and the other end of the coil 113 may be connected with the other lead wire 111 which has the shorter length and is positioned at the initially opened end of the bobbin 110, among the respective lead wires 111.

As a result, when the power is supplied to the lead wires 111, the current is transferred to one end of the coil 113 through one lead wire 111 and passes through the coil 113, and then the current is transferred to the other lead wire 111 through the other end of the coil 113, and as a result, the coil 113 is heated while the current flows along the coil 113.

Then, in the process (B), as illustrated in S40 of FIG. 5, the bobbin 110 of which manufacturing is completed through the process (A) is inserted into the heating tube 120 (S4), and as illustrated in S50 of FIG. 5, the filling material 130 is filled in the heating tube 120 into which the bobbin 110 is inserted (S5).

Herein, the filling material 130 is composed of the magnesium oxide (MgO) powder which forms the insulating member as described above, and the magnesium oxide (MgO) powder as the electrical insulator transfers the heat generated by the coil 113 to the heating tube 120 while maintaining the electrical insulation between the heating tube 120 and the coil 113 and preventing the coil 113 from being moved.

In addition, when filling of the filling material 130 is completed, the insulating cap 140 is mounted on the heating tube 120, the closed end of the heating tube 120 made of the cylindrical metallic material is molded to have the curved surface through the swaging molding, and the formation of the outer-diameter size is completed as the set size, as illustrated in S60 of FIG. 5 (S6).

The closed end of the heating tube 120 is molded to have the curved surface in order to smoothly insert the heating tube 120 into the wax 30 filled in the wax accommodation space.

Herein, the insulating cap 140 seals the inside of the heating tube 120 to serve to prevent the filling material 130 from leaking to the outside of the heating tube 120 and also prevent the foreign materials generated by the ionic change in the filling material 130 caused by the current applied to the coil 113 from leaking.

Meanwhile, in the step S6 of completing the formation of the outer-diameter size of the heating tube 120, the connection of the coil 113 and each lead wire 111 may be strengthened together with the filling material 130 while completing the formation of the outer-diameter size of the heating tube 120 as the set size.

In addition, in the process (C), first, the closed end of the heating tube 120 of which the formation of the outer-diameter size is completed through the process (B) is press-fitted in and mounted on the joining body 150 so that a predetermined part of the closed end protrudes as illustrated in S70 of FIG. 5 (S7), and the bush 160 is mounted on the end of the joining body 150 at which the respective lead wires 111 which protrude from the heating tube 120 protrude to the outside as illustrated in S80 of FIG. 5 (S8).

Herein, the bush 160 fixes each penetrated lead wire 111 while sealing the inside of the joining body 150 to serve to prevent the lead wires 111 from being short-circuited in the joining body 150 by the impact energy including the vibration generated while the vehicle is driven, and strengthen the connection with the power connector (not illustrated).

Then, when mounting of the bush 160 on the joining body 150 is completed, the circumference of the outer periphery of the end of the joining body 150 on which the bush 160 is mounted is curling (pursing) molded (S9) to complete manufacturing of the cartridge heater, as illustrated in S90 of FIG. 5.

As described above, the cartridge heater 100 for the thermostat according to the exemplary embodiment of the present invention, which is manufactured while sequentially performing the respective steps S1 to S9 including the processes (A), (B), and (C), may be more conveniently and easily mounted on the wax cylinder 10, and the filling material 130 filled in the heating tube 120 and the foreign materials generated by the ionic change in the filling material 130 due to the flow of the current are prevented from leaking to the outside of the heating tube 120 to improve operating reliability of the cartridge heater 100.

Therefore, when the cartridge heater 100 for the thermostat and the manufacturing method of the same according to the exemplary embodiments of the present invention configured as such are applied, the filling material 130 as the electrical insulating material which is filled in the heating tube 120 in the electronic thermostat and the foreign materials which may be generated due to the ionic change in the filling material 130 caused by continuously applying power even at the time of stopping supply of the power may be prevented from leaking to the outside to prevent the malfunction of the thermostat.

Further, the heating tube is smoothly inserted into the wax 30 while preventing the heating tube 120 from being separated by press-fitting the heating tube 120 into the joining body 150, and the heating tube 120 is more conveniently mounted in the wax cylinder 10 of the thermostat by applying a screw joining structure to improve mountability and reduce a required time for mounting.

In addition, the malfunction of the thermostat is prevented and operating reliability of the cartridge heater 100 is improved to increase reliability and responsiveness of the thermostat, thereby improving overall marketability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cartridge heater for a thermostat inserted into wax that reciprocatively moves a piston while being expanded and contracted according to a temperature in a wax cylinder embedded in the thermostat and used for selectively transferring heat to the wax depending on whether power is applied, the cartridge heater comprising:
a bobbin around which a coil connected with each of lead wires connected with external power and inserted therein is wound on the outer periphery thereof;
a heating tube of which one end is closed and the other end is initially opened, the bobbin being inserted toward the closed end from the initially opened end therein, such that the lead wires protrude to the outside and the closed end is inserted into the wax;
a filling material filled in the heating tube into which the bobbin is inserted;
an insulating cap mounted on the initially opened end of the heating tube in which the filling material is filled while being penetrated by the lead wires; and
a joining body mounted on the other end of the heating tube and joined to the wax cylinder while covering the outer periphery of the closed end of the heating tube.

2. The cartridge heater for a thermostat of claim 1, wherein the insulating cap seals the inside of the heating tube.

3. The cartridge heater for a thermostat of claim 1, wherein the heating tube strengthens a connection of the lead wires and the coil together with the filling material while formation of an outer-diameter size is completed as a set size through swaging molding in a state where the insulating cap is mounted.

4. The cartridge heater for a thermostat of claim 1, wherein the heating tube is made of a cylindrical metallic material and the closed end is formed with a curved surface.

5. The cartridge heater for a thermostat of claim 1, wherein the heating tube is press-fitted into the joining body.

6. The cartridge heater for a thermostat of claim 1, wherein in the joining body, a thread is formed along the circumference of the outer periphery, and the joining body is screw-joined to the wax cylinder through the thread.

7. The cartridge heater for a thermostat of claim 1, wherein a bush is mounted on the joining body, and fixes the lead wires that protrude to the outside from the end which is to that of the heating tube.

8. The cartridge heater for a thermostat of claim 7, wherein the outer periphery of the end of the joining body on which the bush is mounted is formed to be inclined through curling (pursing) molding.

9. The cartridge heater for a thermostat of claim 1, wherein the filling material is composed of magnesium oxide (MgO) powder which forms an insulating member.

10. The cartridge heater for a thermostat of claim 1, wherein one end of the coil is connected with one lead wire and the other end is connected to another lead wire among the respective lead wires.

11. A manufacturing method of a cartridge heater for a thermostat, the method comprising:
(A) a process of inserting lead wires into a bobbin and connecting the lead wires to a coil wound around the bobbin;
(B) a process of mounting the bobbin manufactured through the process (A) in a heating tube and completing formation of an outer-diameter size of the heating tube while filling a filling material in the heating tube; and
(C) a process of mounting the heating tube of which the formation of the outer-diameter size is completed through the process (B) in a joining body and fixing the lead wires.

12. The method of claim 11, wherein the process (A) includes:
inserting the lead wires into the bobbin;
winding the coil on the outer periphery of the bobbin; and
connecting respective ends of the coil wound on the outer periphery of the bobbin with the respective lead wires.

13. The method of claim 12, wherein in the connecting of the coil and the lead wires, among the respective lead wires, one end of the coil is connected to one lead wire and the other end of the coil is connected with the other lead wire.

14. The method of claim 11, wherein the process (B) includes:
inserting the bobbin into the heating tube:
filling the filling material into the heating tube into which the bobbin is inserted;
mounting an insulating cap on the heating tube filled with the filling material;
and completing formation of an outer-diameter size of the heating tube through swaging molding.

15. The method of claim 14, wherein the filling material is composed of magnesium oxide (MgO) powder which forms an electrical insulating member.

16. The method of claim 14, wherein the insulating cap seals the inside of the heating tube to prevent the filling material from leaking to the outside of the heating tube.

17. The method of claim 14, wherein in the completing of the formation of the outer-diameter size of the heating tube, connection of the coil and the respective lead wires together with the filling material is strengthened while completing the formation of the outer-diameter size of the heating tube as a set size.

18. The method of claim 14, wherein in the completing of the formation of the outer-diameter size of the heating tube, a closed end of the heating tube made of a cylindrical metallic material is molded to have a curved surface.

19. The method of claim 11, wherein the process (C) includes:
press-fitting and mounting the closed end of the heating tube of which the formation of the outer-diameter size is completed through the process (B) in and on the joining body so that a predetermined part of the closed end of the heating tube protrudes;
mounting a bush on the end of the joining body from which the respective lead wires which protrude from the heating tube protrude to the outside; and
curling (pursing) molding the circumference of the outer periphery of the end of the joining body on which the bush is mounted.

20. The method of claim 19, wherein the bush fixes the respective penetrated lead wires while sealing the inside of the joining body.
